(19) United States
(12) Patent Application Publication
(10) Pub. No.: US 2012/0166769 A1
(43) Pub. Date: Jun. 28, 2012

(54) PROCESSOR HAVING INCREASED PERFORMANCE VIA ELIMINATION OF SERIAL DEPENDENCIES

(75) Inventors: Jay E. Fleischman, Fort Collins, CO (US); Ranganathan Sudhakar, Santa Clara, CA (US)

(73) Assignee: ADVANCED MICRO DEVICES, INC., Sunnyvale, CA (US)

(21) Appl. No.: 12/979,946

(22) Filed: Dec. 28, 2010

(51) Int. Cl. G06F 9/40; G06F 9/38

(52) U.S. Cl. 712/216; 712/E09.05

(57) ABSTRACT

Methods and apparatuses are provided for achieving increased performance via elimination of serial dependencies in instructions or instruction sequences. The apparatus comprises an operational unit for determining whether an instruction will cause dependencies during completion in an execution unit. Responsive to that determination the instruction is replaced with an alternative instruction for completion in the execution unit. In this way, the alternative instruction is completed without causing dependencies in the execution unit. The method comprises determining that an instruction will cause dependencies during completion in a processor and replacing the instruction with an alternative instruction for completion in the processor.

### TECHNICAL FIELD

The subject matter presented here relates to the field of information or data processing. More specifically, this invention relates to the field of implementing a processor achieving increased performance via elimination of serial dependencies in instructions or instruction sequences.

### BACKGROUND

Information or data processors are found in many contemporary electronic devices such as, for example, personal computers, personal digital assistants, game playing devices, video equipment and cellular phones. Processors used in today's most popular products are known as hardware as they comprise one or more integrated circuits. Processors execute software to implement various functions in any processor based device. Generally, software is written in a form known as source code that is compiled (by a complier) into object code. Object code within a processor is implemented to achieve a defined set of assembly language instructions that are executed by the processor using the processor's instruction set. An instruction set defines instructions that a processor can execute. Instructions include arithmetic instructions (e.g., add and subtract), logic instructions (e.g., AND, OR, and NOT instructions), and data instructions (e.g., move, input, output, load, and store instructions). As is known, computers with different architectures can share a common instruction set. For example, processors from different manufacturers may implement nearly identical versions of an instruction set (e.g., an x86 instruction set), but have substantially different architectural designs.

To meet the ever growing demand for increased processor performance, processor architectures are continually evolving. When a new or next generation processor is released, it is generally compatible with code previously compiled for a preceding generation of processor. However, compatible does not mean optimized, and while the prior code will run (without error) on the next generation processor, efficiency may suffer due to dependencies created when the prior code is executed on the next generation processor. As is well known in the art, dependencies can cause delay where one instruction is required to wait for the completion of another instruction. Serial dependencies result when instructions or sequence of instructions must be performed in a certain order, which hinders the efficiency of super-scalar or multi-threaded processors. Sometimes, these dependencies can arise due to architectural enhancements or added functionality in the next generation processor. Not only can the previously written code not take full advantage of enhanced functionality of the next generation processor, but running the previously written code reduces the efficiency of the next generation processor due to the creation of instruction (or sequence of instruction) dependencies. Conventional approaches to attempt to recover some of the lost efficiency include running a software-based screening and patch program on top of the executable code to try and patch some of the dependencies. Another approach is to simply re-compile the source code using a new compiler alternative for the new processor architecture. However, this latter approach is generally cost prohibitive for large bodies of software previously written for the prior model processor.

### BRIEF SUMMARY OF THE EMBODIMENTS

An apparatus is provided for achieving increased performance via elimination of serial dependencies in instructions or instruction sequences. The apparatus comprises an operational unit for determining whether an instruction will cause dependencies during completion in an execution unit. Responsive to a determination that the instruction will cause dependencies a unit will replace the instruction with an alternative instruction for completion in the execution unit. In this way, the alternative instruction is completed without causing dependencies in the execution unit.

A method is provided for achieving increased performance via elimination of serial dependencies in instructions. The method comprises determining that an instruction will cause dependencies during completion in a processor and replacing the instruction with an alternative instruction for completion in the processor.

In another embodiment, a method is provided for achieving increased performance via elimination of serial dependencies in instruction sequences. The method comprises determining that one or more instructions in a sequence of instructions will cause dependencies during completion in a processor and replacing the one or more instructions with alternative instructions for completion in the processor.

In yet another embodiment, a method is provided for achieving increased performance via elimination of serial dependencies in instruction sequences. The method comprises determining that one or more instructions in a sequence of instructions will cause dependencies during completion in a processor and replacing the entire sequence of instructions with an alternative sequence of instructions for completion in the processor.

### BRIEF DESCRIPTION OF THE DRAWINGS

The present invention will hereinafter be described in conjunction with the following drawing figures, wherein like numerals denote like elements, and

FIG. 1 is a simplified exemplary block diagram of processor suitable for use with the embodiments of the present disclosure;

FIG. 2 is a simplified exemplary block diagram of operational unit suitable for use with the processor of FIG. 1;

FIG. 3 is a simplified exemplary block diagram for eliminating dependencies according to one embodiment of the present disclosure; and

FIG. 4 is a flow diagram illustrating an exemplary method for eliminating dependencies according to one embodiment of the present disclosure.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. Moreover, as used herein, the word “processor” encompasses any type of information or data processor, including, without limitation, Internet access processors, Intranet access processors, personal data processors, military data processors, financial data processors, navigational processors, voice processors, music processors, video processors or any multimedia processors. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, the following detailed description or for any particular processor microarchitecture.

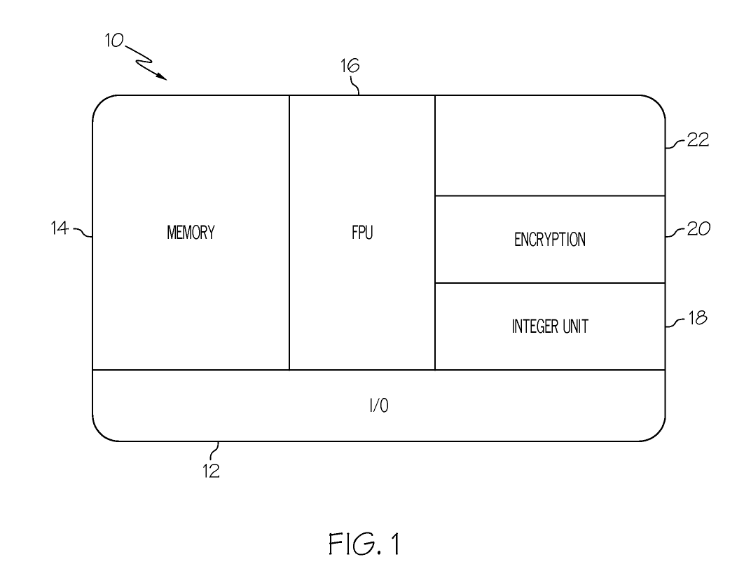

Referring now to FIG. 1, a simplified exemplary block diagram is shown illustrating a processor 10 suitable for use with the embodiments of the present disclosure. In some embodiments, the processor 10 would be realized as a single core in a large-scale integrated circuit (LSIC). In other embodiments, the processor 10 could be one of a dual or multiple core LSIC to provide additional functionality in a single LSIC package. As is typical, processor 10 includes an input/output (I/O) section 12 and a memory section 14. The memory 14 can be any type of suitable memory. This would include the various types of dynamic random access memory (DRAM) such as SDRAM, the various types of static RAM (SRAM), and the various types of non-volatile memory (PROM, EPROM, and flash). In certain embodiments, additional memory (not shown) “off chip” of the processor 10 can be accessed via the I/O section 12. The processor 10 may also include a floating-point unit (FPU) 16 that performs the float-point computations of the processor 10 and an integer processing unit 18 for performing integer computations. Within a processor, numerical data is typically expressed using integer or floating-point representation. Mathematical computations within a processor are generally performed in computational units designed for maximum efficiency for each computation. Thus, it is common for processor architecture to have an integer computational unit 18 and a floating-point computational unit 16. Additionally, an encryption unit 20 and various other types of units (generally 22) as desired for any particular processor microarchitecture may be included.

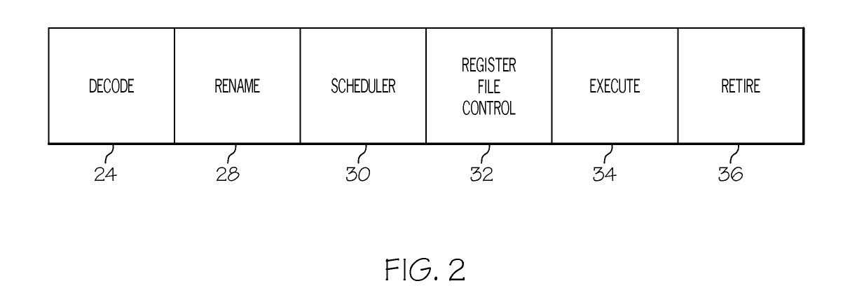

Referring now to FIG. 2, a simplified exemplary block diagram of a computational unit (e.g., 16, 18) suitable for use with the processor 10 is depicted. In one embodiment, the architecture shown in FIG. 2 could operate as the floating-point unit 16, while in other embodiments FIG. 2 could illustrate the integer unit 18. For this particular example, the computational unit (16, 18) includes, without limitation, decode unit 24, rename unit 26, scheduler unit 28, register file control 32, one or more execution units 34 and retire unit 36.

In operation, the decode unit 24 decodes the incoming operation-codes (opcodes) to be dispatched for the computations or processing. The decode unit 24 is responsible for the general decoding of instructions (e.g., x86 instructions and extensions thereof) and how the delivered opcodes may change from the instruction. The decode unit 24 will also pass on physical register numbers (PRNs) from a available list of PRNs (often referred to as the Free List (FL)) to the rename unit 26.

The rename unit 26 maps logical register numbers (LRNs) to the physical register numbers (PRNs) prior to scheduling and execution. According to various embodiments of the present disclosure, the rename unit 26 can be utilized to rename or remap logical registers in a manner that eliminates the need to store known data values in a physical register. In one embodiment, this is implemented with a register mapping table stored in the rename unit 26. According to the present disclosure, renaming or remapping registers saves operational cycles and power, as well as decreases latency.

The scheduler 28 contains a scheduler queue and associated issue logic. As its name implies, the scheduler 28 is responsible for determining which opcodes are passed to execution units and in what order. In one embodiment, the scheduler 28 accepts renamed opcodes from rename unit 26 and stores them in the scheduler 28 until they are eligible to be selected by the scheduler to issue to one of the execution pipes.

The register file control 32 holds the physical registers. The physical register numbers and their associated valid bits arrive from the scheduler 30. Source operands are read out of the physical registers and results written back into the physical registers. In one embodiment, the register file control 32 also check for parity errors on all operands before the opcodes are delivered to the execution units. In a multi-pipelined (super-scalar) architecture, an opcode (with any data) would be issued for each execution pipe.

The execute unit(s) 34 may be embodied as any generation purpose or specialized execution architecture as desired for a particular processor. In one embodiment the execution unit may be realized as a single instruction multiple data (SIMD) arithmetic logic unit (ALU). In another embodiment, dual or multiple SIMD ALUs could be employed for super-scalar and/or multi-threaded embodiments, which operate to produce results and any exception bits generated during execution.

In one embodiment, after an opcode has been executed, the instruction can be retired so that the state of the floating-point unit 16 or integer unit 18 can be updated with a self-consistent, non-speculative architected state consistent with the serial execution of the program. The retire unit 36 maintains an in-order list of all opcodes in process in the floating-point unit 16 (or integer unit 18 as the case may be) that have passed the rename 26 stage and have not yet been committed by to the architectural state. The retire unit 36 is responsible for committing all the floating-point unit 16 or integer unit 18 architectural states upon retirement of an opcode.

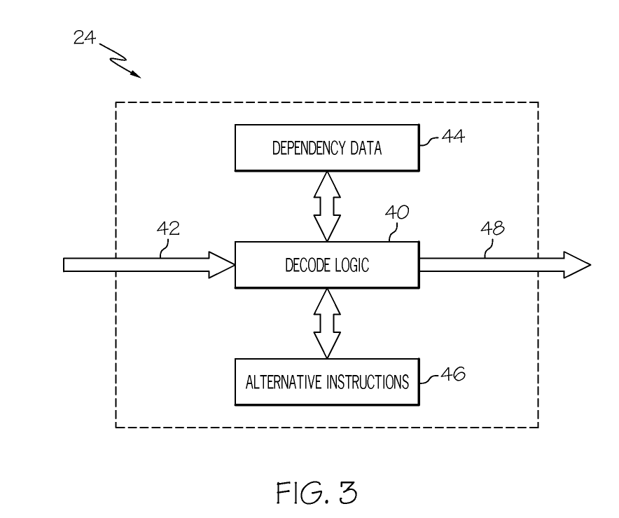

Referring now to FIG. 3, there is shown an illustration of an exemplary block diagram useful for reducing or eliminating dependencies. In the illustrated example, the decoder 24 (see FIG. 2) is shown to include decode logic 40, which receives (or fetches) instructions on bus 42. Upon decoding an instruction (or instruction sequence) the decode logic 40 compares the instructions to dependency data for instructions known to cause dependencies due to the architecture of the processor 10. In one embodiment, the comparison could be implemented using conventional combinational logic. In another embodiment, a state machine could be used as is known in the art. If a dependency is detected, the instruction is held (stored) and replaced with an alternative instruction (or instruction sequence) 46 known to produce the same functional result as the original instruction, but without being subject to the same dependency. In one embodiment, the alternate instruction is optimized for the processor architecture. In the case of instruction sequences, one embodiment determines that the entire sequence will (or is likely) to cause dependencies and replaces the entire sequence of instructions with an alternative instruction sequence. In another embodiment, it could be determined that one or more of the instructions in sequence of instructions will cause dependencies and only those instructions are replaced. In yet another embodiment, upon detecting that one instruction of an instruction sequence will (or is likely) to cause dependencies, the entire sequence of instructions is replaced with alternative instructions. The final instruction(s) (original or alternative) are sent on to the next unit (via bus 48) for further processing (if any) scheduling and execution.

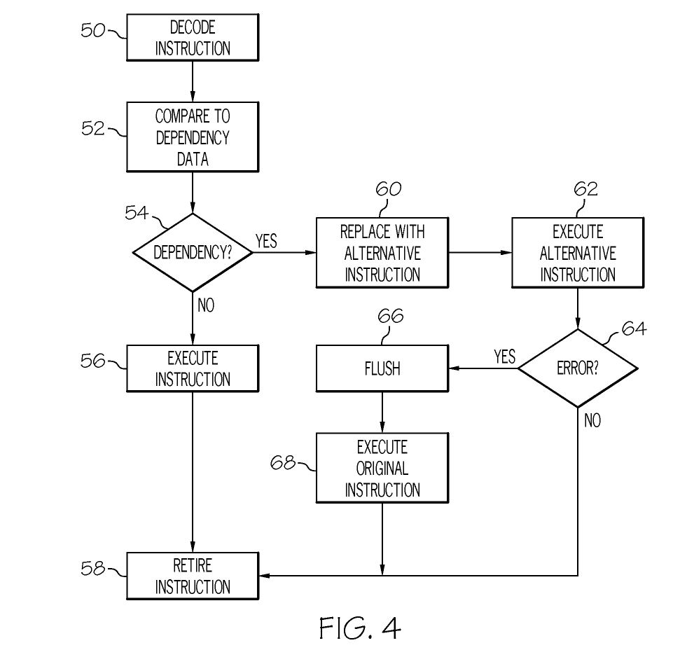

Referring now to FIG. 4, a flow diagram is shown illustrating the steps followed by various embodiments of the present disclosure for the processor 10, the floating-point unit 16, the integer unit 18 or any other unit 22 of the processor 10 that desires to reduce or eliminate dependencies. The various tasks performed in connection with the process of FIG. 4 may be performed by software, hardware, firmware, or any combination thereof. For illustrative purposes, the following description of the process of FIG. 4 may refer to elements mentioned above in connection with FIGS. 1-3. In practice, portions of process of FIG. 4 may be performed by different elements of the described system. It should also be appreciated that the process of FIG. 4 may include any number of additional or alternative tasks and that the process of FIG. 4 may be incorporated into a more comprehensive procedure or process having additional functionality not described in detail herein. Moreover, one or more of the tasks shown in FIG. 4 could be omitted from an embodiment of the process of FIG. 4 as long as the intended overall functionality remains intact.

Beginning in step 50, the instruction is decoded. Next, step 52 compares the instruction to dependency data (44 of FIG. 3) and decision 54 determines whether the instruction is known (or likely) to cause dependences due to the architecture of the processor 10. If not, then the instruction is executed (step 56) and retired in step 58. In one embodiment, the dependency data (44 of FIG. 3) may comprise a table listing instructions known to result in dependencies.

However, if the determination of decision 54 is that the instruction will (or may) cause dependencies, the original instruction is held (stored) and replaced with an alternative instruction (or instruction sequence) (step 60). In one embodiment, the alternative instruction(s) are optimized for the architecture of the processor 10. The alternative instruction is executed in step 62 (in lieu of the original instruction) and decision 64 determines if an error or interrupt has occurred, whether due to the substitution of the alternative code for the original code or not. Although illustrated as occurring after execution of the alternative instruction, those skilled in the art understand the error detection or interrupts may occur at various points during instruction scheduling or execution in an operation unit of a processor. In the case of instruction sequences, one embodiment determines that the entire sequence will (or is likely) to cause dependencies and replaces the entire sequence of instructions with an alternative instruction sequence. In another embodiment, it could be determined that one or more of the instructions in the sequence of instructions will cause dependencies and only those instructions are replaced. In yet another embodiment, upon detecting that one instruction of an instruction sequence will (or is likely) to cause dependencies, the entire sequence of instructions is replaced with alternative instructions so as to minimize the occurrence of errors during completion. In any event, if no error has occurred, then the alternative instruction is retired (step 58) and the efficiency of the processor (or operational unit) has been enhanced and latency reduced due to the use of the alternative instruction instead of the original instruction.

However, since backward compatibility should be preserved in any next generation processor, if an error is detected by decision 64, the state of the operational unit is flushed and returned to a non-speculative architected state. Thus, the operational unit is returned to a state that is consistent with its state of the operational unit prior to substituting the alternative code for the original code. The original code is then retrieved and executed (even though it is less efficient due to dependencies) and the original instruction is retired. In this way, efficiency is enhanced and latency reduced for each possible instruction, while maintaining backward compatibility for previously written code.

Various processor-based devices may advantageously use the processor (or computational unit) of the present disclosure, including laptop computers, digital books, printers, scanners, standard or high-definition televisions or monitors and standard or high-definition set-top boxes for satellite or cable programming reception. In each example, any other circuitry necessary for the implementation of the processor-based device would be added by the respective manufacturer. The above listing of processor-based devices is merely exemplary and not intended to be a limitation on the number or types of processor-based devices that may advantageously use the processor (or computational unit) of the present disclosure.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A method, comprising:
determining that a first instruction will cause dependencies during completion in a processor; and
eliminating the dependencies by replacing the first instruction with a second instruction that will not cause the dependencies.

2. The method of claim 1, wherein:
determining further comprises determining that a sequence of instructions will cause dependencies during completion in a processor; and
eliminating further comprises replacing the sequence of instructions with an alternative sequence of instructions for completion in the processor.

3. The method of claim 1, further comprising determining if an error has occurred during completion of the second instruction.

4. The method of claim 1, further comprising flushing completion of the second instruction and completing the first instruction in the processor.

5. The method of claim 4, further comprising retiring the first instruction after completion of the first instruction.

6. The method of claim 1, further comprising the step of retiring the second instruction after completion of the second instruction

7. The method of claim 1, wherein determining further comprises comparing the first instruction to data representing instructions known to cause dependencies during completion.

8. The method of claim 1, wherein eliminating further comprises replacing the first instruction with the second instruction for completion in the processor, whereby the second instruction produces a result identical to the first instruction had it been completed.

9. A method, comprising:
determining that one or more instructions in a sequence of instructions will cause dependencies during completion in a processor; and
replacing the one or more instructions with alternative instructions for completion in the processor thereby eliminating the dependencies.

10. The method of claim 9, wherein replacing further comprises replacing all instructions in the sequence with alternative instructions responsive to the determination that the one or more instructions in a sequence of instructions will cause dependencies during completion in the processor.

11. The method of claim 9, further comprising determining if an error has occurred during completion of any of the alternative instructions.

12. The method of claim 11, further comprising flushing completion of the alternative instructions and returning the processor to a known state.

13. The method of claim 12, further comprising completing the instruction in the processor after the processor has returned to the known state.

14. A processor, comprising:
an operational unit for determining whether an instruction will cause dependencies during completion in an execution unit; and
a unit within the operational unit responsive to a determination that the instruction will cause dependencies to replace the instruction with an alternative instruction for completion in the execution unit;
wherein, the alternative instruction is completed without causing dependencies in the execution unit.

15. The processor of claim 14, further comprising a unit for determining whether an error has occurred during completion of the alternative instruction in the execution unit.

16. The processor of claim 15, further comprising a unit for returning the operational unit to a known state.

17. The processor of claim 14, further comprising a unit for comparing the instruction to data representing instructions known to cause dependencies during completion in the execution unit of the processor.

18. The processor of claim 14, further comprising:
the operational unit configured to determine whether one or more instructions in a sequence of instructions will cause dependencies during completion in an execution unit; and
the unit being configured to replace the one or more instructions in the sequence of instructions with an alternative sequence of instruction for completion in the execution unit.

19. The processor of claim 14, further comprising a scheduling unit for scheduling the sequence of alternative instructions for completion in the execution unit.

20. The processor of claim 14, further comprising other circuitry to implement one of the group of processor-based devices consisting of: a computer; a digital book; a printer; a scanner; a television or a set-top box.
